(19) United States
(12) Patent Application Publication
(10) Pub. No.: US 2016/0078087 A1
(43) Pub. Date: Mar. 17, 2016

(54) QUERY FEATURES AND QUESTIONS

(71) Applicant: HEWLETT-PACKARD DEVELOPMENT COMPANY, L.P., Houston, TX (US)

(72) Inventors: Lei Wang, Beijing (CN); Ye Pan, Shanghai (CN); Shimin Chen, Beijing (CN); Hui Fang, Newark, DE (US); Shicong Feng, Beijing (CN)

(21) Appl. No.: 14/780,734

(22) PCT Filed: Mar. 29, 2013
(86) PCT No.: PCT/CN2013/073467

§ 371 Date: Sep. 28, 2015

(51) Int. Cl. G06F 17/30

(52) U.S. Cl. CPC G06F 17/30448; G06F 17/30867; G06F 17/30528

(57) ABSTRACT

Disclosed herein are techniques for detecting questions in queries. it is determined whether a query comprises a substantially specific question. In one example, past queries related to the current query are used to validate a whether the query comprises the substantially specific question. In another example, query suggestions are used to validate whether the query comprises the substantially specific question.

### BACKGROUND

Users query search engines for various types of information. A search engine may provide a ranked listing of sites based on terms that best match those of a query. The effectiveness of a search engine depends on the relevance of the returned pages. While there may be millions of web pages that include a particular word or phrase, some may be more relevant, popular, or authoritative than others.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a list of example features in accordance with aspects of the present disclosure.

FIG. 4 is an example two dimensional graph illustrating the use of support vector machines in accordance with aspects of the present disclosure.

FIG. 5 is a further flow diagram of an example method in accordance with aspects of the present disclosure.

### DETAILED DESCRIPTION

As noted above, users query search engines for various types of information. Some queries may seek general information about a topic and others may be specific questions. One way to cope with specific questions is to use a vertical search service, such as a question and answer search, product search, or a job search. These services may provide answers to substantially specific questions about a particular topic. For example, community based question and answer (“CQA”) sites allow users to submit questions therein and allow other subscribers to provide answers to those questions. Over time, CCM sites may accumulate a large corpus of questions and answers that may be searchable by a user. Thus, in order to obtain answers to their specific questions, users may need to find these vertical search sites and submit or find their questions therein. While conventional search engines may try to match terms in the question to those of certain web pages (e.g., web pages contained in its indexed database), these pages may not include a relevant vertical search page. Furthermore, even if a search engine is aware of a relevant vertical search page, the search engine may rank it lower in the listing of results.

In view of the foregoing, disclosed herein are a system, non-transitory computer readable medium, and method to determine whether a query comprises a substantially specific question. In one example, this determination may be at least partially based on features of the query. In another example, past queries related to the current query may be used to validate a finding that the query does not comprise the substantially specific question. In yet a further example, query suggestions may be used to validate a finding that the query does comprise the substantially specific question. In another aspect, a substantially specific question may be defined as a phrase that satisfies the following two conditions: first, that the phrase be convertible In a coherent question by adding an interrogative to the beginning of the phrase (e.g., “who,” “what,” “where,” “how,” “when,” or “why”); second, that the phrase be substantially focused such that the answer is not significantly diverse (e.g., “History of the world” would have diverse results).

The techniques disclosed herein may accurately predict whether a current query comprises a substantially specific question. Therefore, rather than ranking pages based on a similarity of terms, a search engine may be caused to target relevant vertical search pages and to rank these pages higher in the results returned to a user. The aspects, features and advantages of the present disclosure will be appreciated when considered with reference to the following description of examples and accompanying figures. The following description does not limit the application; rather, the scope of the disclosure is defined by the appended claims and equivalents.

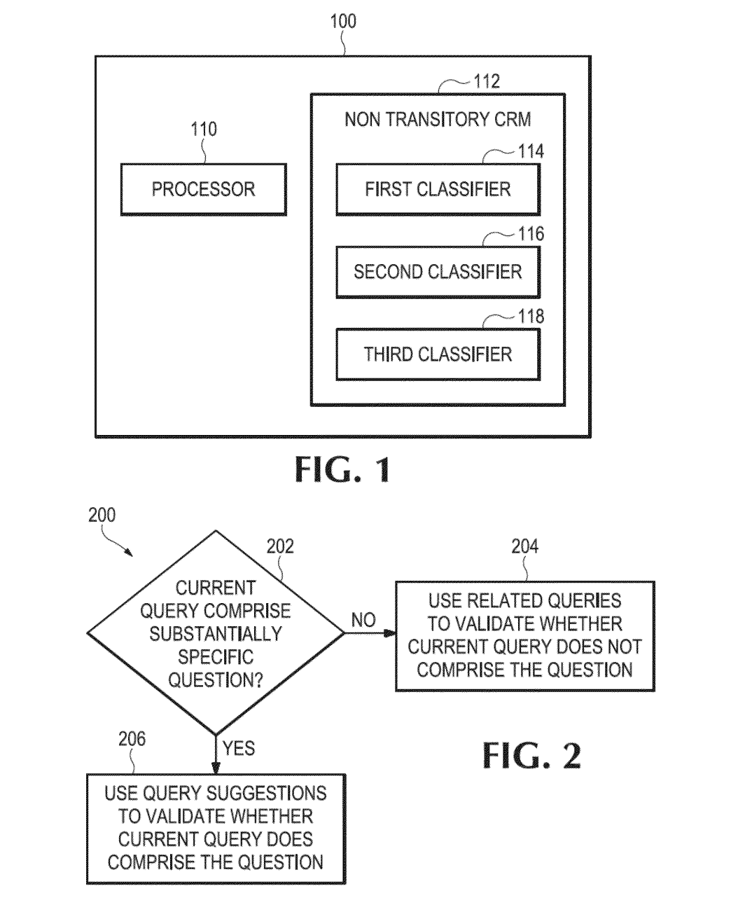

FIG. 1 presents a schematic diagram of an illustrative computer apparatus 100 for executing the techniques disclosed herein. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network. The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. In one example, the instructions may include a first classifier 114, a second classifier 116, and a third classifier 118. Non-transitory CRM 112 may be used by or in connection with any instruction execution system that can fetch or obtain the logic therefrom and execute the instructions contained therein.

Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

As will be discussed in more detail below, first classifier 114 may instruct processor 110 to determine whether a current query comprises a substantially specific question based at least partially on whether the current query comprises a predefined feature. Second classifier 116, may instruct processor 110 to validate a determination of whether the current query comprises the substantially specific question based at least partially on an analysis of past queries that are related to the current query. In a further example, third classifier 118 may instruct processor 110 to validate a determination of whether the current query comprises a substantially specific question based at least partially on an analysis of query suggestions generated by a search engine for the current query.

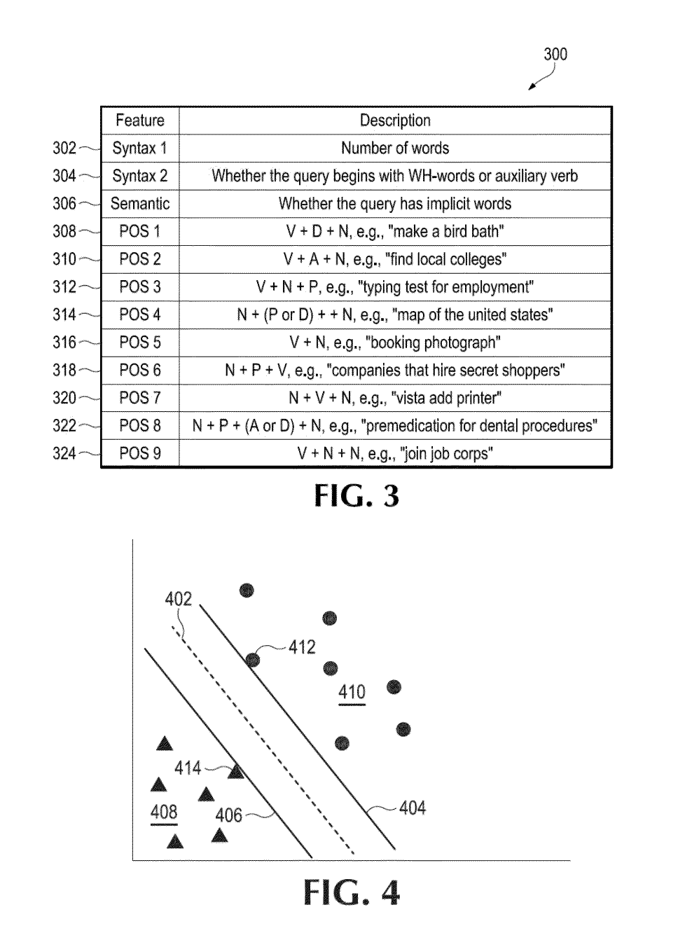

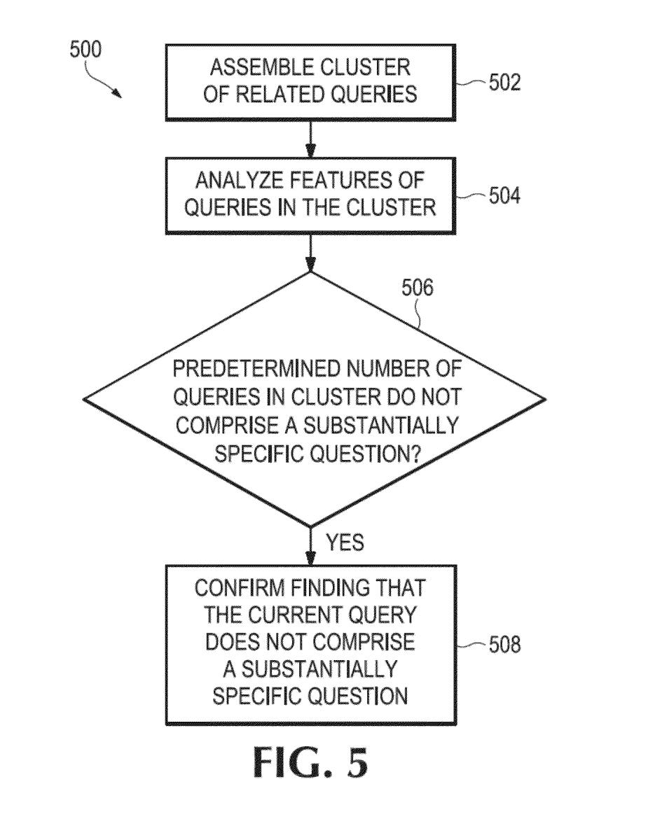

Working examples of the system, method, and non-transitory computer-readable medium are shown in FIGS. 2-5. In particular, FIG. 2 illustrates a flow diagram of an example method 200 for determining whether a query comprises a substantially specific question. FIG. 3 is an example of predefined features that may be used to determine whether a query comprises a substantially specific question. FIG. 4 is a working example of query analysis using support vector machines in accordance with aspects of the present disclosure. The actions shown in FIGS. 3-4 will be discussed below with regard to the flow diagram of FIG. 2. FIG. 5 is a further flow diagram of an example method 500 for validating whether the query comprises a substantially specific question.

As shown in block 202 of FIG. 2, first classifier 114 may determine whether a current query comprises a substantially specific question. Such determination may be based on whether the query comprises a predefined feature indicative of a substantially specific question. As will be explained further below, first classifier 114 may comprise a binary classifier. Such a classifier may use predefined features of training queries to determine whether a new query does or does not comprise a substantially specific question. The features may be detected before execution of first classifier 114 and may be part of the training queries provided as input thereto,

An overview of feature generation will now be discussed. In one example, the query features may be extracted from query logs generated by the Text Retrieval Conference (“TREC”) and American Online (“AOL”). These logs may contain thousands if not millions of queries compiled over a certain time period. In one implementation, a team of researchers may visually determine whether a sample of queries from the logs contain substantially specific questions. After the visual determination is complete, the researchers may extract features of the queries that were visually determined to comprise substantially specific questions. As will be explained in more detail below with regard to FIG, 3, these features may be extracted with the assistance of automated tools. In addition to the feature extraction examples discussed below, other examples may use dimensionality reduction algorithms, such as Kernel principal component analysis, multi-linear principal component analysis, or the like.

In one example, cross validation may be employed to determine which of the extracted features are most indicative of substantially specific questions. Cross validation is a statistical technique for estimating the accuracy of a predictive model. As noted above, researchers may visually determine which queries comprise a substantially specific question and may extract features of these queries using automated tools. Cross validation filters out features that seem significant within the context of a limited data set, but are insignificant generally. Thus, cross validation prevents researchers from accepting that a feature is highly indicative generally based on a limited data set. One round of cross-validation may involve partitioning a sample of data into complementary subsets. One subset may be used as a training set and another set may be used to validate the analysis of the training set. Multiple rounds of cross-validation may be performed using different partitions and the validation results may be averaged over the multiple rounds. In one example, 800 of 1500 queries in a log may be set aside as the training set and 700 queries may be set aside as the validation set.

FIG. 3 illustrates twelve example query features regarded as being indicative of substantially specific questions based on an analysis of the TREC 2009 million query track and the AOL search query log (hereinafter “the logs”). As noted above, these features may be used as a basis for determining whether a future query comprises a substantially specific question. However, it is understood that different query logs may yield different results and that the features shown in FIG. 3 are merely illustrative. The relevant query features may change over time as query trends change.

As shown in FIG. 3, syntax feature 302 may be associated with the number of words in a query. In one example, after visually detecting sample queries from the logs that comprise a substantially specific question, a team of researchers may use ad-hoc automated tools (e.g., Peri scripts, Java applications etc.) to obtain the word lengths of these queries. In one example, cross validation of these queries indicates a strong correlation between substantially specific questions and a number of words in a query. In particular, the analysis shows that queries with approximately 6 or 7 words may be deemed to comprise a substantially specific question

Syntax feature 304 is associated with specific words in a query. For example, one aspect of syntax feature 304 is whether the first word of a query begins with an interrogative (e.g., “where,” “what,” “which,” “when,” “who,” or “how). Another aspect of syntax feature 304 may be associated with auxiliary verbs in the query (e.g., “do,” “shall,” “should,” etc.). Syntax feature 304 may be based on a hypothesis that interrogatives and auxiliary verbs are significant features. In one example, cross validation confirms that these features are highly indicative of substantially specific questions.

Semantic feature 306 may be associated with suggestive words in the query. An analysis of the logs indicates a correlation between certain words and substantially specific questions. In particular, words like “photo,” “coupon,” “website,” and “cause” suggest that queries containing one of these words may be deemed to comprise a substantially specific question. In one example, a team of researchers may track the frequency of particular words found in sample queries that they visually deemed to comprise substantially specific questions. These words may be traced with the assistance of ad-hoc automated tools. Semantic feature 306 may be based on cross validating queries containing these frequently appearing words.

Patterns of speech (“POS”) features 308, 310, 312, 314, 316, 318, 320, 322, and 324 are speech patterns indicative of a substantially specific question based on an analysis of the logs. The POS features may be extracted from the logs using an automated part-of-speech tagging tool, such as those produced by the Stanford University Natural Language Processing Group. Such a tool may associate words in a query with a tag representative of a particular part of speech. The tag assigned to a word may be based on its definition and its context (i.e., its relationship with adjacent and related words in the query). In one example, queries comprising POS features may be extracted from the log and cross validated. In a further example, cross validation of these queries suggests that the POS features shown in FIG. 3 are indicative of substantially specific questions. In the example speech patterns of FIG. 3, “V” indicates a verb; “A” indicates an adjective; “D” indicates an “a,” “an,” or “the;” “P” indicates a preposition; and, “+” is a filler for other words that do not fit into any category. In this example, if one of these POS features is detected in a query, the query may be deemed to comprise a substantially specific question.

As noted above, the detection of a substantially specific question in a current query may be modeled as a binary classification problem. In one example, first classifier 114 may comprise a support vector machine (“SVM”) algorithm, An SVM algorithm is a binary classifier that may be employed to categorize new data into one of two classes (e.g., comprising a substantially specific question or not comprising a substantially specific question) based on a set of training examples. However, it is understood that other algorithms may be employed, such as, but not limited to, naïve Bayes or neural networks. In one example, an SVM algorithm may be provided with a set of training queries and each query therein may be manually labeled as comprising or not comprising a substantially specific question. Moreover, each training query submitted to the SVM process may be accompanied by an associated vector and each value in the vector may correspond to one of the detected features. The SVM algorithm may plot these features in an n-dimensional space such that n is equal to the number of detected features. Since the vectors are already labeled as comprising or not comprising a substantially specific question, the SVM algorithm may associate different patterns of vector values with one of the two categories. By way of example, there may be only two features detected during query analysis: number of words in a query and whether the query begins with an interrogative word. Thus, a training query of “restaurants in shanghai” may be represented by the vector <3, 0>, wherein 3 is the number of words in the query and 0 indicates that the query does not begin with an interrogative word. An SVM algorithm may plot this vector in a two-dimensional space. In a further example, if the twelve features shown in FIG. 3 are detected, an SVM algorithm may plot the training queries corresponding to those features in a 12 dimensional space.

For ease of illustration, FIG. 4. Illustrates an example two dimensional graph that may be generated by an SVM algorithm in accordance with two features. A point in cluster 410 may represent a query that comprises a substantially specific question and a point in cluster 408 may represent a query that does not comprise a substantially specific question. An SVM algorithm may identify a boundary that separates the two classes of queries. This boundary may be referred to as the decision boundary. Thus, one goal of the SVM algorithm is to determine the line, out of all possible lines, that best represents the boundary between the two classes or dusters of queries. In a space of three or more dimensions, this boundary is a hyperplane. In this example, point 412 and point 414 represent support vectors. These support vectors are the most marginal points in their respective clusters that are situated closest to the opposing cluster. The marginal border of each cluster is represented by lines 404 and 406. An SVM algorithm may calculate the midpoint between these two marginal lines so as to delineate the border between the two classes. In this example, line 402 is the boundary between the two clusters.

After the SVM algorithm is trained, it can be used to categorize new queries. When a new query is received, an SVM algorithm may determine which side of the border (e.g., line 402) to plot the new query, based on the features of the new query and the features learned from the training queries. As the distribution changes over time, the SVM algorithm may determine that a new boundary should be defined. As noted above, one goal of the SVM algorithm is to determine the line that best represents the boundary between the two classes or clusters of queries. An SVM algorithm may calculate the midpoint between the two marginal lines tangential to the support vectors. As new queries are received and plotted, a new support vector may emerge. The emergence of a new support vector may cause the SVM algorithm to detect and delineate a new decision boundary.

Referring back to FIG. 2, if it is determined that the current query does not comprise the substantially specific question, second classifier 116 may use related queries to validate this determination, as shown in block 204. In one example, if first classifier 114 determines that the query does not comprise the question, the determination may be validated with a log of related past queries entered by a user. These past queries may contain slight alterations of the current query as the user attempts to rephrase the query. In another example, a related query may be defined as a query that has at least one word in common with the current query. Referring now to FIG. 5, a flow diagram of an example method is shown for validating a finding that a query does not comprise a substantially specific question. As shown in block 502, a cluster of related queries may be assembled. The related queries in the cluster may have an intent that is similar to the current query or the newly received query. Related queries with a different intent than the current query may be ignored. The clustering of related queries with similar intent may be carried out using hierarchical clustering that measures the similarity between a pair of queries. The metric that measures the similarity between a pair of queries may be, for example, a cosine similarity function, a Euclidean distance function, or the like.

As shown in block 504, the features of the queries in the cluster may be analyzed. In one example, the analysis may be an SVM analysis of each query in the cluster. In block 506, it may be determined whether a predetermined number of queries in the cluster do not comprise the substantially specific question. If they do not, the finding by the SVM algorithm that the current query does not comprise the question may be confirmed, as shown in block 508. Otherwise, the finding may be reversed. In one example, a value of 1 may be assigned to every related query in the cluster that does comprise a substantially specific question and a value of −1 may be assigned to every query in the cluster that does not comprise a substantially specific question. Furthermore, the new incoming query or the current query may also be assigned the same values (e.g., 1 for comprising and −1 for not comprising). These values may be added such that, if the sum of the assigned values are less than or equal to a threshold, such as zero, a finding by the SVM algorithm that the current query does not comprise the substantially specific question may be acknowledged or confirmed. By way of example, if a current query c is deemed not to comprise a substantially specific question, the query c is assigned a value of −1. A cluster may comprise three related queries with a matching intent q₁, q₂, and q₃. In order to confirm query c does not comprise a substantially specific question, at least one of the queries in the cluster should not comprise the substantially specific question (i.e., c+q₁+q₂+q₃=−1 +1+1+−1=0). If the sum of the values is greater than zero, the finding by the SVM algorithm may be reversed and the current query may be deemed to comprise the substantially specific question.

Referring back to FIG. 2, if it is determined that the current query does comprise the substantially specific question, third classifier 118 may use query suggestions to validate this determination, as shown in block 206. The current query may be submitted to a leading commercial search engine to obtain query suggestions therefrom. This is based on a hypothesis that search engines are enabled to provide suggestions that are very precise, since search engines typically maintain an accurate log of queries submitted by a user. However, some query suggestions may still be substantially different than the current query. These substantially different query suggestions may be disregarded. In one example, query suggestions that satisfy the following equation may be deemed substantially different:

sim(s,q)min{size(s),size(q)}<0.3

In the equation above, s is the current query or the received query and q is a query suggestion. The function sim may be a function that computes the number of similar words between s and q. The function size may be a function that returns the number of words in a query. A query suggestion satisfying the above equation may be filtered out.

The remaining queries may be counted to determine if the number of remaining query suggestions is within a threshold. In one example, the threshold is approximately three. Thus, if there are less than three remaining queries, the determination that the current query does comprise a substantially specific question may be confirmed. Otherwise, the determination may be reversed. This is based on a hypothesis that a query with too many query suggestions is not likely to comprise a substantially specific question.

Advantageously, the foregoing system, method, and non-transitory computer readable medium predicts whether a query comprises a substantially specific question and validates the prediction. In this regard, rather than comparing terms in the question to terms in web pages that may not be relevant, a search engine can target the relevant vertical search page directly and rank them higher. In turn, users are much more likely to receive direct answers to their questions without having to search the Internet for a specific vertical search site.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a first classifier which, if executed, instructs at least one processor to determine whether a current query comprises a substantially specific question based at least partially on whether the current query comprises a predefined feature;
a second classifier which, if executed, instructs at least one processor to validate a determination of whether the current query comprises the substantially specific question based at least partially on an analysis of past queries that are related to the current query; and
a third classifier which, if executed, instructs at least one processor to validate the determination of whether the current query comprises the substantially specific question based at least partially on an analysis of query suggestions generated by a search engine for the current query.

2. The system of claim 1, wherein the predefined feature comprises a syntax feature, a semantic feature, or a speech pattern feature.

3. The system of claim 1, wherein the related past queries have at least one word in common with the current query.

4. The system of claim 3, wherein if the determination indicates that the current query does not comprise the substantially specific question, the second classifier, if executed, instructs at least one processor to:
assemble a duster of related past queries such that an intent of each query in the duster is substantially similar to that of the current query;
analyze features of queries in the duster; and
if the features indicate that a predetermined number of queries in the duster do not comprise a previous substantially specific question, acknowledge that the current query does not comprise the substantially specific question.

5. The system of claim wherein if the determination indicates that the current query does comprise the substantially specific question, the third classifier, if executed, instructs at least one processor to:
disregard query suggestions that are substantially different than the current query to generate remaining query suggestions; and
if a number of remaining query suggestions is within a predetermined threshold, acknowledge that the current query does comprise the substantially specific question.

6. A non-transitory computer readable medium having instructions therein which, if executed, cause a processor to:
analyze features of a current query to determine whether the current query comprises a substantially specific question;
determine whether past queries related to the current query comprise a prior substantially specific question to validate a finding that the current query does not comprise the substantially specific question; and
analyze query suggestions for the current query generated by a search engine to validate a finding that the current query does comprise the substantially specific question.

7. The non-transitory computer readable medium of claim 6, wherein the instructions therein, if executed, further instruct at least one processor to compare features of the current query to predefined features comprising a syntax feature, a semantic feature, and a speech pattern feature.

8. The non-transitory computer readable medium of claim 6, wherein the related past queries have at least one word in common with the current query.

9. The non-transitory computer readable medium of claim 8, wherein the instructions therein, if executed, further instruct at least one processor to:
assemble a cluster of related past queries such that an intent of each query in the cluster is substantially similar to that of the current query;
analyze features of queries in the cluster; and
if features in the cluster indicate that a predetermined number of queries in the cluster do not comprise the prior substantially specific question, confirm the finding that the current query does not comprise the substantially specific question.

10. The non-transitory computer readable medium of claim 6, wherein the instructions therein, if executed, further instruct at least one processor to:
disregard query suggestions that are substantially different than the current query to generate remaining query suggestions; and
if a number of remaining query suggestions is within a predetermined threshold, confirm the finding that the current query does comprise the substantially specific question.

11. A method comprising:
determining, using at least one processor, whether a current query has a feature indicating that the current query comprises a substantially specific question;
if a determination indicates that the current query does not comprise the substantially specific question, validating, using at least one processor, the determination based at least partially on features of former queries related to the current query; and
if the determination indicates that the current query does comprise the substantially specific question, validating, using at least one processor, the determination based at least partially on an analysis of query suggestions generated for the current query by a search engine.

12. The method of claim 11, wherein the feature indicating that the current query comprises the substantially specific question comprises a syntax feature, a semantic feature, or a speech pattern feature.

13. The method of claim 11, wherein the related former queries have at least one word in common with the current query.

14. The method of claim 13, further comprising
assembling, using at least one processor, a duster of related past queries such that an intent of each query in the duster is substantially similar to that of the current query;
analyzing, using at least one processor, features of queries in the duster; and
if features in the query indicate that that a predetermined number of queries in the duster do not comprise a prior substantially specific question, confirming, using at least one processor, that the current query does not comprise the substantially specific question.

15. The method of claim 11, further comprising:
disregarding, using at least one processor, query suggestions that are substantially different than the current query to generate remaining query suggestions; and
if a number of remaining query suggestions is within a predetermined threshold, confirming, using at least one processor, that the current query does comprise the substantially specific question.
